(19) United States
(12) Patent Application Publication
(10) Pub. No.: US 2011/0308068 A1
(43) Pub. Date: Dec. 22, 2011

(54) MODIFIED INTUBATION TUBE AND FORMATION

(76) Inventors: Scott Russell, North Ridgeville, OH (US); Heather Russell, North Ridgeville, OH (US); Brian Asquith, Cleveland, OH (US)

(21) Appl. No.: 13/166,585

(22) Filed: Jun. 22, 2011

Related U.S. Application Data
(60) Provisional application No. 61/357,285, filed on Jun. 22, 2010.

(51) Int. Cl. B23P 17/04; B23P 19/00

(52) U.S. Cl. 29/592; 29/700

(57) ABSTRACT

A configuration of an endotrachael intubation tube is provided to facilitate placement of the endotrachael intubation tube in a trachea without aid of a laryngoscope. Further, means for shaping the configuration of the endotrachael intubation tube are provided. A beveled location is also provided to facilitate alignment of the distal end of the endotrachael intubation tube during shaping.

### CROSS-REFERENCE TO RELATED APPLICATIONS

This application claims priority to U.S. Provisional Patent Application Ser. No. 61/357,285 entitled “MODIFIED INTUBATION TUBE AND FORMATION” filed Jun. 22, 2010, the entirety of which application is incorporated herein by reference.

### TECHNICAL FIELD

Embodiments described herein relate generally to configuration of an endotracheal intubation tube and means for achieving the configuration.

### BACKGROUND

Intubation is a process whereby a tube is placed into an external or internal orifice of the body. One particular form of intubation is tracheal intubation. Tracheal intubation involves the placement of an endotracheal intubation tube (ET) in the trachea to establish an airway for mechanical ventilation while protecting a patient's airway. Placement of an ET is commonly performed in conjunction with a laryngoscope (LS), with the ET being directed to the trachea, via the mouth and passing the larynx and vocal chords. A LS can be employed to facilitate viewing of the vocal chords, glottis, etc., to assist in placement of the ET. The distal end of the ET can be located in the trachea by means of inflating a bulb near the distal end of the ET and secured in the mouth by tape or the like. The bulb further protects the airway by preventing ingress of blood, vomit, secretions, or other matter from entering the airway.

During administration of an ET, a stylet is inserted into the ET to facilitate shaping of the ET to a desired curvature and to provide the ET with sufficient rigidity to allow the ET to be inserted into the trachea. The stylet comprises a malleable material (e.g., aluminum) which, when placed inside the ET, can be formed to provide the ET with the necessary curvature to be placed in the trachea. Further, while malleable, the stylet has sufficient rigidity to impart rigidity to the ET facilitating placement of the ET in the trachea. Once the ET is in place, the stylet can be removed (e.g., withdrawn) from the ET and the position of the ET is secured by various means such as an inflatable bulb incorporated into the ET, as well as taping the ET to the patient's mouth/face, for example.

A plurality of ET's are available having different lengths and diameters, where a particular diameter/length combination employed can depend upon the physiology of the patient. ET's having the larger diameter/longer length can be used on patients having a large physiology. Accordingly, as physiology reduces a smaller diameter/shorter length ET can be utilized.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

An endotracheal intubation tube (ET) and stylet combination are presented having a configuration to facilitate manual placement of the ET/stylet combination without being aided by a laryngoscope (LS). The ET/stylet combination are configured with a first curve A and a second curve B. Further, the ET can be marked to indicate positioning of curve A, curve B, etc.

The ET can be shaped by hand, with a shaping block, or preconfigured by the manufacturer/supplier.

A plurality of shaping blocks facilitating the desired configuration of the ET/stylet combination are presented, in accord with various exemplary, non-limiting embodiments.

Further, a beveled locating surface can be employed to facilitate alignment of the beveled distal end of the ET in relation to the configuration of curves (e.g., curves A and B) shaped in the ET.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates system 110 comprising an endotracheal tube with included stylet having a shape according to an embodiment of the subject innovation.

FIG. 2 illustrates system 200, a forming block for provisioning a shape to an endotracheal tube according to an embodiment of the subject innovation.

FIG. 3 illustrates system 300, a forming block for provisioning a shape to an endotracheal tube according to an embodiment of the subject innovation.

FIG. 4 illustrates system 400, a forming block for provisioning a shape to an endotracheal tube according to an embodiment of the subject innovation.

FIG. 5 illustrates system 500, comprising a forming block for provisioning a shape to an endotracheal tube, and an endotracheal tube in-situ, according to an embodiment of the subject innovation.

FIGS. 6a and 6b illustrate system 600, a forming block for provisioning a shape to an endotracheal tube according to an embodiment of the subject innovation.

FIG. 7 illustrates a flow for fabrication of an endotracheal tube in accordance with one or more embodiments of the subject innovation.

FIG. 8 illustrates a flow for fabrication of a forming block in accordance with one or more embodiments of the subject innovation.

FIG. 9 illustrates a flow for fabrication of a forming block in accordance with one or more embodiments of the subject innovation.

### DETAILED DESCRIPTION

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the disclosed information when considered in conjunction with the drawings.

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices may be shown in block diagram form in order to facilitate describing the claimed subject matter.

Situations can occur where a LS may not be available for use for locating an ET. Such situations can be a result of cost issues (e.g., a medical center having a limited budget cannot afford an LS), unavailability of an LS at a given time, the patient has undergone such trauma that use of an LS is not appropriate owing to critical condition of the patient or they have undergone such injury that placement of the LS may not be suitably performed in the airway/trachea. Alternatively, visualization of the airway/trachea may be impaired/unattainable owing to a large amount of body fluids (e.g., blood, vomit, etc.) located in the airway/trachea thereby reducing the applicability of a LS to facilitate placement of an ET.

In such situations a quick and relatively safe means for placing the ET is required where a LS is not available/appropriate for use. The phrase “relatively safe” is a balance between the possible physical damage to the patient in administering an ET versus the chance that a patient could die if the ET is not employed. When administering an ET in a surgical setting, e.g., in an operating theatre, the person (e.g., a nurse) placing the ET has a relatively large amount of time to effect correct placement of the ET to ensure that the patient has sufficient oxygen to the lungs. However, a flight nurse, paramedic, firefighter, or the like, arriving at the scene of an accident often finds themselves faced with a situation where time is of the essence and, without airway management being immediately established, the patient could undergo serious injury (e.g., brain damage), or death.

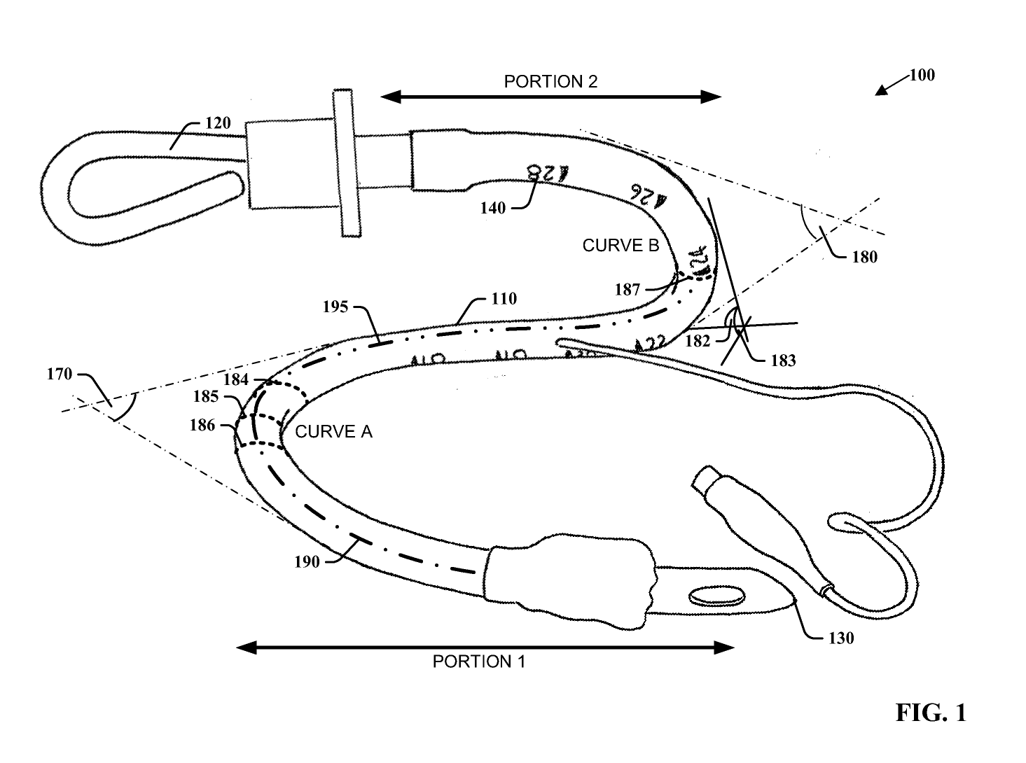

Rather than employing an LS and using the LS to assist in locating the ET into the patient's trachea, of concern are those situations where an LS is not available, or cannot be used, and an ET has to be “blindly” placed. By forming the ET (in conjunction with the stylet) it is possible to obtain a configuration that facilitates placement of the ET without the use of an LS. An exemplary, non-limiting configuration is shown in FIG. 1. The ET 110, in conjunction with a stylet 120, is formed with two curves—curves A and B. Curve A is formed to allow suitable placement of the tube into the trachea, portion 1. Curve B effectively creates a handle/fulcrum, portion 2, to facilitate positioning of the ET 110 into a trachea. While FIG. 1 illustrates ET 110 formed with a configuration suitable for placement by a righthanded person, a mirror configuration can be produced for use by a lefthanded person. It is to be appreciated that the actual configuration employed can be of personal preference to the person applying the ET 110.

In one aspect, ET 110 can be provided in a pre-configured form from a manufacturer. Any suitable mechanical means can be utilized to provision configuration of ET 110. A forming block having a profile to generate the correct shaping of ET 110 can be utilized. When supplied pre-configured from the manufacturer, ET 110 can be provided with the stylet 120 already inserted into ET 110, with stylet 120 providing the necessary rigidity to allow the ET 110 to be formed and the formed shape to be maintain between manufacture and use. It is to be appreciated that while a forming block (e.g., blocks 210, 310, and 410) provides an example of provisioning shaping of ET 110, other suitable forming means can be utilized. For example, apparatus comprising hydraulic/pneumatic means can be employed to provision formation. In one embodiment ET 110 and stylet 120 can be placed between opposing and offset pistons which upon operation, e.g., respective forward motion of the pistons, ET 110 and stylet 120 are bent and formed to the desired configuration.

In another aspect, ET 110 can be shaped on an as-needed basis, e.g., at the scene of an accident. Typically, ET 110 and stylet 120 are received from a manufacturer in an unassembled form, e.g., ET 110 and stylet 120 are separately packaged. In one embodiment, stylet 120 can be placed in ET 110 and then the ET 110/stylet 120 combination can be formed manually by bending the ET 110/stylet 120 combination to facilitate forming into the desired shape. In an alternative aspect, ET 110/stylet 120 combination can be formed into the desired shape using a forming block (e.g., blocks 210, 310, and 410).

As shown in FIG. 1, curve A and curve B have respective angles 170 and 180. Angles 170 and 180 can be of any desired magnitude to facilitate manual placement of the ET 110/stylet 120 combination in the patient's trachea/airway. In exemplary, non-limiting embodiment, angle 170 of curve A can be in the order of 50°. However, owing to the various aspects involving size of ET 110 (e.g., length, diameter, etc.), patient physiology, etc., a degree of variation is to be expected, with angle 170 being in the range of approximately 40°-60°, or portion thereof. It is to be appreciated, as mentioned, it may not be possible to provide an absolute magnitude for angle 170, and any suitable angle to facilitate placement of the ET 110 is considered to be within the scope of the subject application and various non-exemplary embodiments presented herein. Similarly, the magnitude of angle 180 is also in the range approximately 40°-60°, thereby facilitating portion 2 of ET 110/stylet 120 combination to act as a handle/fulcrum. Further, the angle of the portion of the ET 110/stylet 120 combination comprising curve B with respect the portion of the ET 110/stylet 120 combination comprising curve A can also be considered (e.g., angles 182 and 183) whereby curve B and portion 2 are acting as a fulcrum/handle for placement of the ET 110/stylet 120 combination.

In placing the ET 110/stylet 120 combination, the distal end 130 of the ET 110/stylet 120 combination is placed in the patient's mouth and portion 1 is fed through the larynx, past the vocals chords and located in the trachea. The curve of portion 1 enables the ET 110/stylet 120 combination to be located without having to employ a LS. Once the ET 110/stylet 120 combination is deemed to be correctly located (e.g., distal end 130 is located in the trachea), the second curve, portion 2, can be straightened to facilitate removal of the stylet 120 from ET 110.

An ET 110 is typically provisioned with depth markings 140 to indicate the depth to which an ET 110 is to be placed in the patient. For example, a 7 mm diameter ET can have markings ranging from 16 cm to 28 cm along the length of the ET. In one aspect the ET 110/stylet 120 combination can be formed based upon the physiology of the patient. For example, an ET 110/stylet 120 combination for use with a small framed person may be bent at about 19 cm. For a large framed person the ET 110/stylet 120 combination may be bent at about 21-23 cm. It is to be appreciated that a range of ET 110/stylet 120 combination's are available having a range of ET 110 diameters and lengths. For example, while the ET 110 previously mentioned has a diameter of 7 mm, tubes having diameters of 5, 5.5, 6, 6.5, 7, 7.5, 8 mm, etc. are also available and the subject innovative aspects can be equally applied to any ET 110/stylet 120 combination regardless of the tube diameter.

In a further, exemplary, non-limiting embodiment, markings can be placed on ET 110 to aid identification of how ET 110 is to be shaped to facilitate formation of curves A and B. As shown in FIG. 1, markings 185 and 187 can be placed (e.g., printed) on ET 110 to indicate respective position of curve A and curve B, thereby enabling a person (e.g., flight nurse) to shape the ET 110/stylet 120 combination by hand. In a further, exemplary, non-limiting embodiment, lines 190 and 195 can be placed (e.g., printed) on ET 110 to demarcate the respective shaped regions of ET 110, e.g., portion 1, curve A, curve B, portion 2, etc., thereby enabling a person (e.g., flight nurse) to shape the ET 110/stylet 120 combination by hand. Any of markings 185 and 187, and lines 190 and 195, can comprise of a plurality of markings/lines thereby enabling a person shaping the ET 110 to determine respective bend points in the ET 110 based upon the tube diameter, tube length, and tube physiology. For example, marking 185 can comprise of a plurality of accompanying markings, 184, 186, indicating where curve A should be formed for a person having respective, small frame, medium frame, large frame physiology, etc.

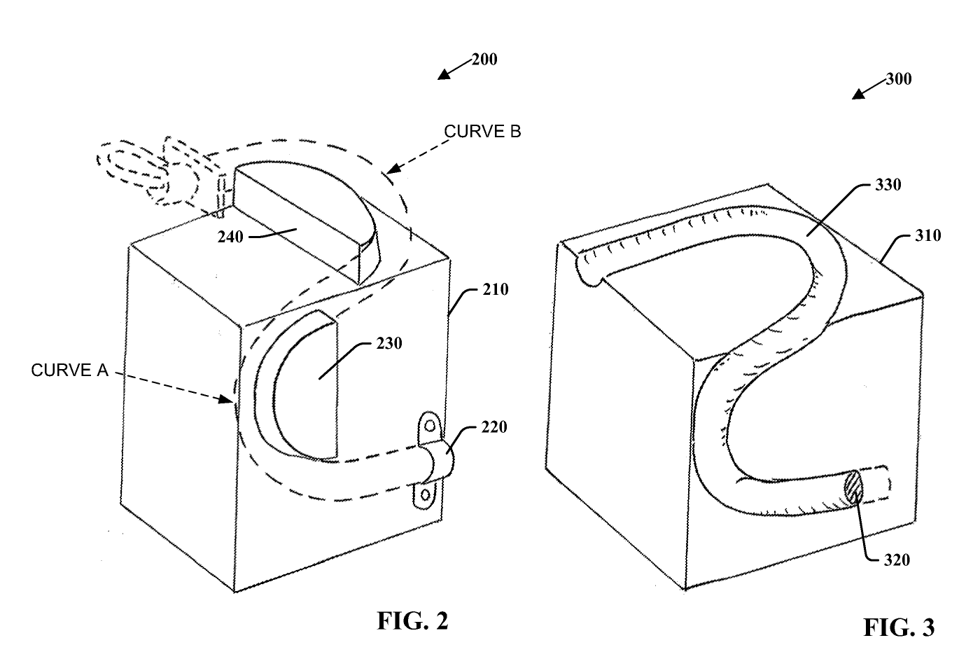

An exemplary, non-limiting embodiment of a forming block facilitating shaping of the ET 110/stylet 120 combination is shown in FIG. 2, system 200. The forming block has a shape suitable to impart the desired configuration to the ET 110/stylet 120 combination. Located on block 210 are a locating means 220, first curve forming section 230 and second curve forming section 240. The distal end 130 of ET 110 can be placed in locating means and with the distal end 130 sufficiently located and secured, the ET 110/stylet 120 combination can be formed around the first forming section 230 to form curve A and then formed around the second curve forming section 240 to form the second curve in the ET 110, curve B. Location of an ET 110 is indicated on the forming block in FIG. 2, as a hashed outline. Once the desired shape has been formed, the ET 110/stylet 120 combination can be removed and is ready to be utilized.

Forming block 210 (and similarly, blocks 310 and 410) can be loosely carried (e.g., in an airway management bag) or the forming block 210 can be secured to a vehicle conveying medical personnel, e.g., a medflight helicopter, fire engine, emergency response vehicle, etc. The forming block 210 can be secured to any suitable location of the vehicle, e.g., to the bulkhead, frame, etc. and an ET 110 having the desired form can be prepared as needed. For example, in an accident report received by a flight nurse traveling to the location of an accident, information can be requested/conveyed regarding the patients airway. Accordingly, if necessary, the flight nurse can assemble an ET 110/stylet 120 combination and form the desired shape (e.g., system 100) using forming block 210 prior to arrival at the scene of the accident.

FIG. 3 illustrates an exemplary, non-limiting embodiment system 300, a forming block for shaping the ET 110/stylet 120 combination to a desired configuration. System 300 comprises a forming block 310 into which has been machined a locating hole 320 and shaped recess 330. While in FIG. 2 the locating means 220 is indicated as U-shaped fitting attached to block 210 it is to be appreciated that the locating means can be of any suitable manner to facilitate location of distal end 130. For example, locating means 320 can be a hole formed (e.g., by machining, casting, and the like) located in block 310 into which distal end 130 can be inserted. With distal end 130 sufficiently located and constrained in hole 320 ET 110/stylet 120 combination can be pressed into the shaped recess 330 with the shaped recess 330 acting as a guide to impart the desired shape to the ET 110/stylet 120 combination. Once formed to the desired configuration the ET 110/stylet 120 combination can be removed, with the ET 110/stylet 120 combination having a shape shown in FIG. 1.

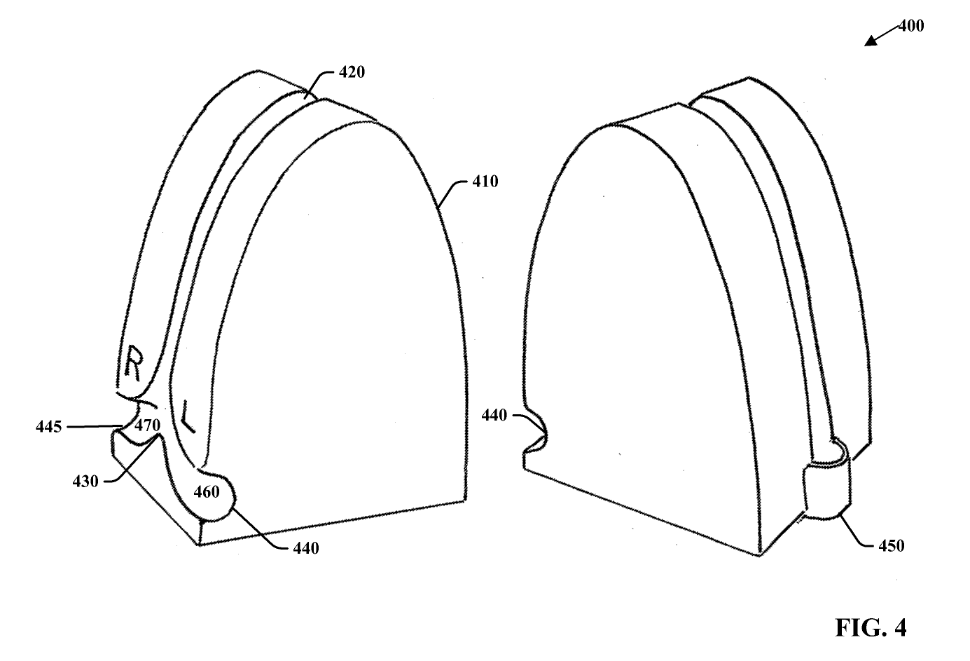

FIG. 4 illustrates system 400, a forming block for shaping the ET 110/stylet 120 combination to a desired configuration. System 400 comprises a forming block 410 comprising respective grooves 420 and 430 (becoming 460 or 470 depending on ‘handedness’ configuration) for shaping the ET 110/stylet 120 combination. To facilitate shaping of the ET 110/stylet 120 combination, the distal end 130 of ET 110 is placed in the locator 450. With the distal end 130 of ET 110 located in locator 450, the ET 110/stylet 120 combination is laid into groove 420 and wrapped, in groove 420, around the block, thereby forming curve A of the ET 110/stylet 120 combination as shown in FIG. 1. To form curve B, at the respective position the ET 110/stylet 120 combination is laid into the groove initiating at 430 and going out to the end of the block respectively at 440 (lefthand configuration) or 445 (righthand configuration), thereby forming curve B in the ET 110/stylet 120 combination. As shown in FIG. 4, at point 430, the ET 110/stylet 120 combination can either be turned in direction 460 to facilitate shaping of the ET 110/stylet 120 combination to be employed in a left hand manner. Alternatively, at point 430, the ET 110/stylet 120 combination can be turned in direction 470 to facilitate shaping of the ET 110/stylet 120 combination to be employed in a right hand manner.

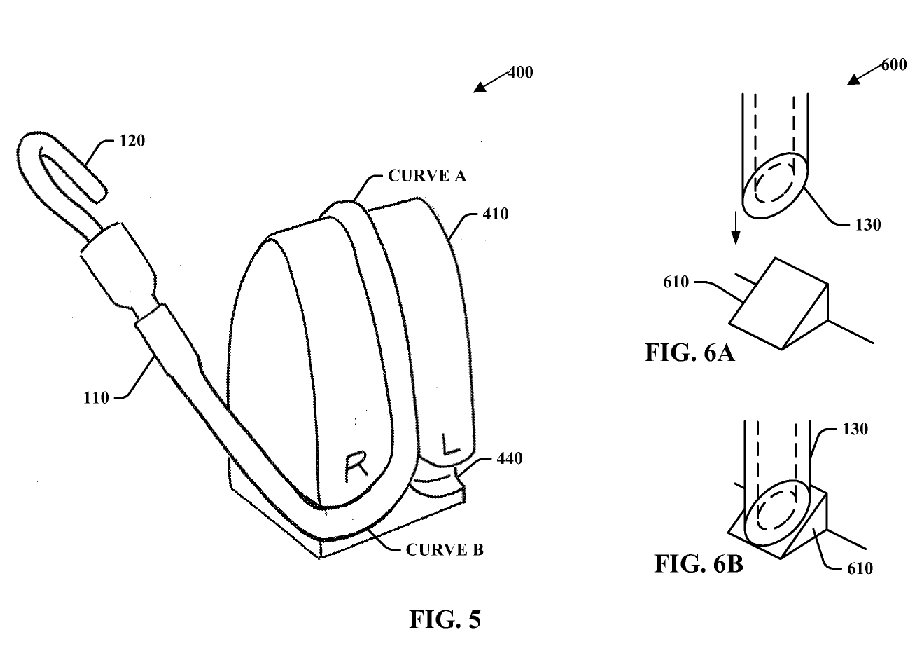

FIG. 5 illustrates system 500, depicting an ET 110/stylet 120 combination having been shaped by block 410, prior to removal of the ET 110/stylet 120 combination from the block 410. As shown in FIG. 5, curve A of the ET 110/stylet 120 combination has been formed in groove 420, and curve B of the ET 110/stylet 120 combination being formed in groove 430 to form a right hand orientated configuration.

FIG. 6, illustrates an exemplary, non-limiting embodiment of a locator (e.g., locator 450) including a beveled surface to facilitate location and orientation of the distal end 130 of the ET 110. Typically, the distal end 130 is angled at approximately 45° to facilitate ease of placement of the ET 110 into the patient's airway/trachea. To facilitate alignment of the distal end 130 with respect to the final shape of the ET 110 locator 450 can have included therein a beveled surface 610, which the distal end 130, during placement of the ET 110 on the shaping block (e.g., blocks 210, 310 or 410), is brought up against, thereby aligning the 45° end of the distal end 130 with respect to the shaping block (e.g., blocks 210, 310 or 410).

It is to be appreciated that any suitable means can be employed to facilitate forming of the ET 110/stylet 120 combination. For example, in another embodiment the forming block can comprise of a half-moon shaped block, the ET 110/stylet 120 combination is placed on the block to facilitate forming of curve A to create Portion 1 (See FIG. 1), while the ET 110/stylet 120 combination could then be turned through the appropriate angle (e.g., 90 degrees) and upside down and placed on the half-moon block to facilitate forming of curve B to create Portion 2.

It is to be appreciated that any suitable material can be employed to facilitate manufacture of systems 200, 300, and 400 for employment in a medical setting. Forming block(s) 210, 310, or 410 can be formed from polymer, resin, metal, ceramic, composite, etc. Such materials include stainless steel, PEEK, etc., and any other material (such as readily referenced by the American Society of Materials “Materials and Processes for Medical Devices”, etc.). Further, block(s) 210, 310, or 410 can be fabricated by any suitable forming means such as machining, casting, injection molding, near-net shape forming, etc.

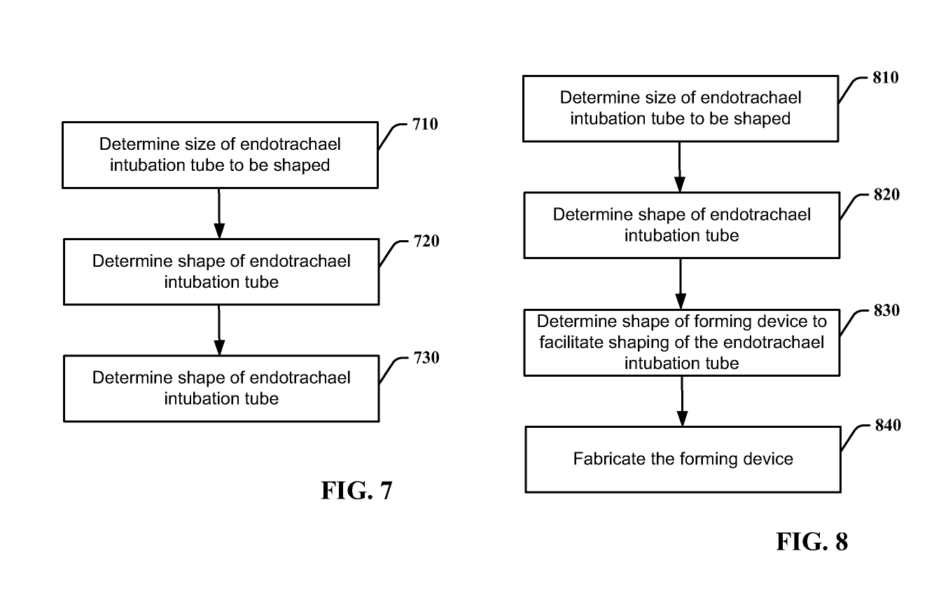

FIG. 7, presents a flow diagram illustrating an exemplary, non-limiting embodiment for forming an endotracheal tube (e.g., ET 110). At 710, a determination is made regarding the size of the endotracheal tube (ET) to be shaped. As described above, endotracheal tubes are available in a plurality of diameters and lengths, and based upon such factors as patient physiology, an endotracheal tube is selected.

At 720, the shape with which the endotracheal tube is to be formed is determined. Consideration is made of the length of respective portions of the endotracheal tube in the final configuration (e.g., portion 1, portion 2), placement of curves (e.g., curve A, curve B), angles of curves (e.g., angle 170, angle 180, angle 182, angle 183), etc. Further, the orientation of the bevel at the distal end 130 can be taken into consideration to enable ease of placement of the shaped endotracheal tube in the patient's trachea. Furthermore the endotracheal tube can include markings to facilitate identification of the respective position at which the endotracheal tube is to be shaped, e.g., where to form curve A, curve B, length of portion A, length of portion B, etc.

At 730, once the respective shape to configure the endotracheal tube has been determined, the endotracheal tube is shaped to the desired configuration. In one aspect, the endotraceal tube can be formed by hand (e.g., by a flight nurse at the scene of an accident). In another aspect, the endotracheal tube can be formed using a forming block (e.g., forming blocks 210, 310, or 410). In a further aspect, the endotracheal tube can be preconfigured to a particular shape by the manufacturer/supplier of the endotracheal tube and supplied to the recipient (e.g., hospital) in a preconfigured shape.

FIG. 8, presents a flow diagram illustrating an exemplary, non-limiting embodiment for forming an endotracheal tube (e.g., ET 110). At 810, a determination is made regarding the size of the endotracheal tube (ET) to be shaped. As described above, endotracheal tubes are available in a plurality of diameters and lengths.

At 820, the configuration of the endotracheal tube is determined with regard to the length of respective portions of the endotracheal tube (e.g., length of portion 1, length of portion 2), positioning of curves (e.g., curves A and B), and angles (e.g., angle 170, angle 180) in the desired shape.

At 830, a correlation is made between the size and configuration of the endotracheal tube and a shaping profile to facilitate shaping of the endotracheal tube. From the correlation a shaping profile is determined.

At 840, a forming device (e.g., any of shaping blocks 210, 310, or 410) is fabricated with the determined shaping profile.

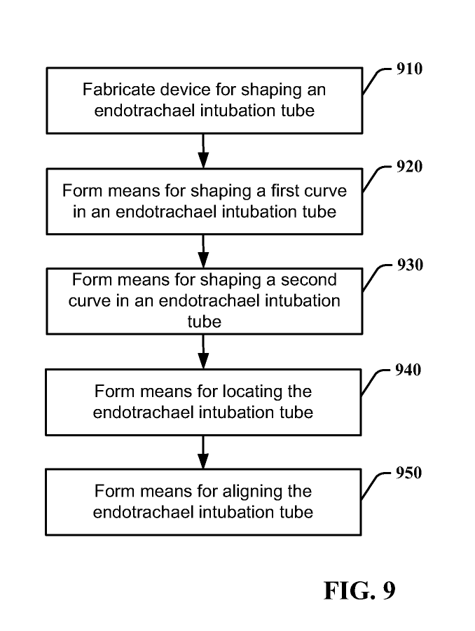

FIG. 9, presents a flow diagram illustrating an exemplary, non-limiting embodiment for forming an endotracheal tube (e.g., ET 110). At 910 a device (e.g., any of shaping blocks 210, 310, or 410) is fabricated to facilitate shaping an endotracheal tube with a desired configuration. The device can be fabricated from any suitable material applicable to a medical environment, e.g., metal, polymer, ceramic, composite, etc.

At 920 means for forming a first curve (e.g., curve A) in the endotracheal tube is formed in the shaping block. Such forming can be by machining, or designing a mould for formation of the shaping block to be cast into, injection moulded, etc.

At 930 means for forming a second curve (e.g., curve B) in the endotracheal tube is formed in the shaping block.

At 940 means for locating the distal end (e.g., end 130) of the endotracheal tube are incorporated into the shaping block. Means for locating can be a hole in the shaping block into which the distal end of the endotracheal tube is inserted. Alternatively the means for locating can be a bracket attached to the shaping block into which the distal end of the endotracheal tube is located.

At 950 means for aligning the endotracheal tube during shaping can be incorporated into the shaping block. The distal end of an endotracheal tube is typically cut with a 45° angle. A beveled surface (e.g., 610) can be incorporated into the shaping block to facilitate alignment of the distal end to facilitate location of the distal end in the trachea.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the subject specification. Furthermore, to the extent that the term “includes” is used in either the detailed description or the claims, such term is intended to be inclusive in a manner similar to the term “comprising” as “comprising” is interpreted when employed as a transitional word in a claim.

What has been described above includes examples of the disclosed innovation. It is, of course, not possible to describe every conceivable combination of components or methodologies for purposes of describing the disclosed innovation, but one of ordinary skill in the art can recognize that many further combinations and permutations of the disclosed innovation are possible. Accordingly, the disclosed innovation is intended to embrace all such alterations, modifications and variations that fall within the spirit and scope of the appended claims. Furthermore, to the extent that the term “contain,” “includes,” “has,” “involve,” or variants thereof is used in either the detailed description or the claims, such term can be inclusive in a manner similar to the term “comprising” as “comprising” is interpreted when employed as a transitional word in a claim.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

Further, while certain embodiments have been described above, it is to be appreciated that these embodiments have been presented by way of example only, and are not intended to limit the scope of the claimed subject matter. Indeed, the novel methods and devices described herein may be made without departing from the spirit of the above description. The accompanying claims and their equivalents are intended to cover such forms or modifications as would fall within the scope and spirit of the subject innovation.

In addition, it should be appreciated that while the respective methodologies provided above are shown and described as a series of acts for purposes of simplicity, such methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

What is claimed is:

1. A system for forming an endotrachael intubation tube, comprising:
a forming block; and
a locator for location of the endotrachael intubation tube.

2. The system of claim 1, wherein a surface of the locator is beveled to facilitate alignment of the distal end of the endotrachael intubation tube.

3. The system of claim 2, wherein the beveled distal end of the endotrachael intubation tube is located against the beveled surface of the locator.

4. The system of claim 1, wherein the forming block comprises a first curved surface to facilitate formation of a first curve in the endotrachael intubation tube.

5. The system of claim 4, wherein the first curved surface facilitates forming the first curve with an angle of about 50°.

6. The system of claim 4, wherein the first curved surface facilitates forming the first curve with an angle in the range between 40°-60°.

7. The system of claim 4, wherein the forming block further comprises a second curved surface to facilitate formation of a second curve in the endotrachael tube.

8. The system of claim 7, wherein the second curve in the endotrachael tube can be formed to facilitate lefthanded operation or righthanded operation.

9. A system for forming an endotrachael intubation tube, comprising:
means for forming a first curve in the endotrachael intubation tube; and
means for locating the endotrachael intubation tube during forming of the first curve.

10. The system of claim 9, wherein a surface of the means for locating is beveled facilitating alignment of the distal end of the endotrachael intubation tube.

11. The system of claim 10, wherein the beveled distal end of the endotrachael intubation tube is located against the beveled surface of the means for locating.

12. The system of claim 9, wherein the means for forming a first curve facilitate forming the first curve with an angle of about 50°.

13. The system of claim 9, wherein the means for forming a first curve facilitate forming the first curve with an angle in the range between 40°-60°.

14. The system of claim 9, further comprising means for forming a second curve in the endotrachael intubation tube.

15. The system of claim 9, wherein the means for forming the first curve are utilized to form the second curve in the endotrachael intubation tube.

16. A method for forming an endotrachael intubation tube, comprising:
forming a first curve in the endotrachael intubation tube; and
forming a second curve in the endotrachael intubation tube.

17. The method of claim 16, wherein the first curve has an angle of about 50°.

18. The method of claim 16, further comprising a first marking on the endotracheal intubation tube indicating position of the first curve.

19. The method of claim 18, further comprising a second marking on the endotracheal intubation tube indicating an alternative position of the first curve.

20. The method of claim 19, wherein the first marking and second marking are placed in accord with patient physiology.
